(19) United States
(12) Patent Application Publication
(10) Pub. No.: US 2003/0209233 A1
(43) Pub. Date: Nov. 13, 2003

(54) Magnetic pre-treatment of air and fuel

(76) Inventors: Anders Thalberg, Torp (NO); Terje Gudmundsen, Oslo (NO)

Correspondence Address: WENDEROTH, LIND & PONACK, L.L.P., 2033 K STREET N. W., SUITE 800, WASHINGTON, DC, 20006-1021, US

(21) Appl. No.: 10/387,411

(22) Filed: Mar. 14, 2003

(30) Foreign Application Priority Data
Mar. 15, 2002 (NO) 2002 1297

(51) Int. Cl. F02M 27/00

(52) U.S. Cl. 123/539

(57) ABSTRACT

The present invention relates to a device for magnetic pre-treatment of air passing through an air intake supply leading to a combustion chamber, said magnetic pre-treatment being carried out by means of magnetic elements. The present invention is characterized in that at least two magnetic elements are arranged on one side of and adjacent to said air intake supply, said at least two magnetic elements being oriented with their dipole direction pointed mainly perpendicularly to an axial incoming direction of said air intake supply, the at least two magnetic elements further being arranged substantially next to each other with alternating pole orientations, the dipole direction of said magnetic elements being arranged in succession in the order N, S, N . . . etc. or S, N, S . . . etc.

The present invention relates to a device for magnetic pre-treatment of air and/or fuel, said air and/or fuel being on its way into an engine for combustion, in which the air and/or fuel is influenced by a magnetic field.

Today's motor industry is continuously met by ever increasing demands and requirements for cleaner and more effective combustion in order to increase output and reduce environmentally hazardous emissions. Incomplete combustion of fuel in an engine results in a lower power output and an increase in environmentally hazardous emissions. The motor industry has attached this problem from just about every angle and has also continuously improved the engines as this work as progressed. Advanced injection systems have been developed that optimises the delivery and mixture of air and fuel to the engine. Valve technology has been further refined in order to optimise the relation between torque, output, wear, and fuel consumption. In the field of materials technology, strength has been increased and weight has been reduced both with respect to all moving parts in the engine and the total weight of the vehicle, at the same time as catalysers for the treatment of emissions have been refined. Strict requirements have been set on the quality of oil and fuel, in order to ensure constant and optimal work conditions for the engine while at the same time reducing the emissions of the combustion. Work is done to further develop so-called hybrid solutions combining the combustion engine with an electric motor. The power industry is faced with similar challenges and solutions are being developed where nitrogen is removed from the air in order to eliminate emissions of so-called NOX-gases, in addition attempts are made to store CO₂ in order to eliminate emissions of CO₂ to the atmosphere that contribute to the greenhouse effect.

Regardless of which method is chosen to reduce emissions, it is of great importance that the actual combustion is as complete as possible.

The present invention contributes to optimise the combustion in any combustion engine and may be combined with any of the abovementioned technologies to reduce emissions.

The prior art has suggested that it may be advantageous to let fuel pass some kind of magnetic field before combustion. The claimed result has been a reduction of unwanted emissions, but it has not been clearly proven that this pre-treatment has resulted in significant fuel consumption savings.

U.S. Pat. No. 5,331,807 describes an apparatus for magnetically conditioning incoming air and fuel to an internal combustion engine to improve engine operation. The air and fuel, including diesel fuel, are subject to the lines of force from opposite poles of permanent magnets mounted on the air and fuel inlet lines. According to claim 1 of this U.S. patent, it is a significant feature that “. . . said inlet line [is] exposed to the magnetic field emanating substantially from only one pole . . . ” and that “. . . the first and second permanent magnets means [are] in a bipolar arrangement so that the incoming air and fuel are subject to the magnetic fields from opposite poles.”

U.S. Pat. No. 4,050,426 describes a fuel-treating device arranged in a fuel line, with successive magnetic domains of alternating alignment providing at least three longitudinally spaced apart sections of alternating north and south polarity.

It is an aim of the present invention to provide a device for pre-treatment of air and/or fuel on its way into an engine for combustion, which device forms a magnetic field that influences air and/or fuel flowing towards the engine, giving as a result an improved combustion as compared to the prior art.

Furthermore, It is an aim of the present invention to provide a device for pre-treatment of air and/or fuel on its way into an engine for combustion that not only improves the emissions, but also results in significantly reduced fuel consumption.

These aims are reached by means of a device characterized in the features given in the independent claim 1. Further advantages are reached by the features given in the independent claims.

The following description describes preferred non-limiting embodiments of the present invention with reference to the drawings, in which;

FIG. 1 shows a preferred embodiment of the present invention where the magnets are arranged outside the air intake line or fuel delivery line,

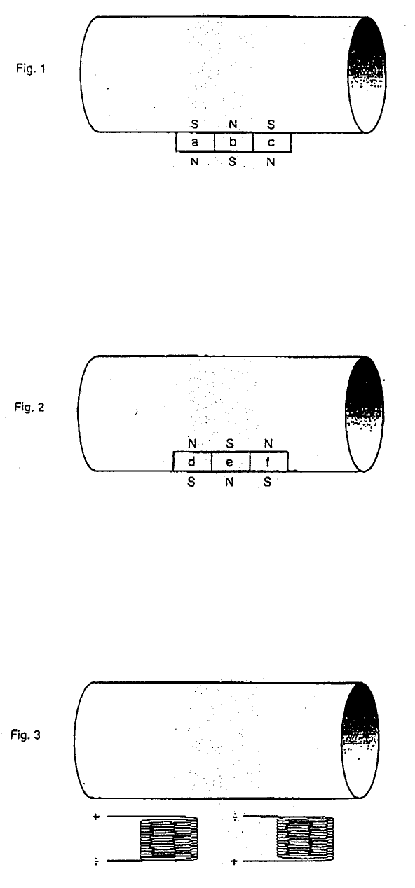

FIG. 2 shows an embodiment of the present invention where the magnets are arranged inside the air intake line,

FIG. 3 shows an embodiment of the present invention using electromagnetic means,

FIG. 4 shows one possible arrangement of the orientation of the magnets shown in FIGS. 1 and 2,

FIG. 5 shows another possible arrangement of the orientation of the magnets shown in FIGS. 1 and 2, and

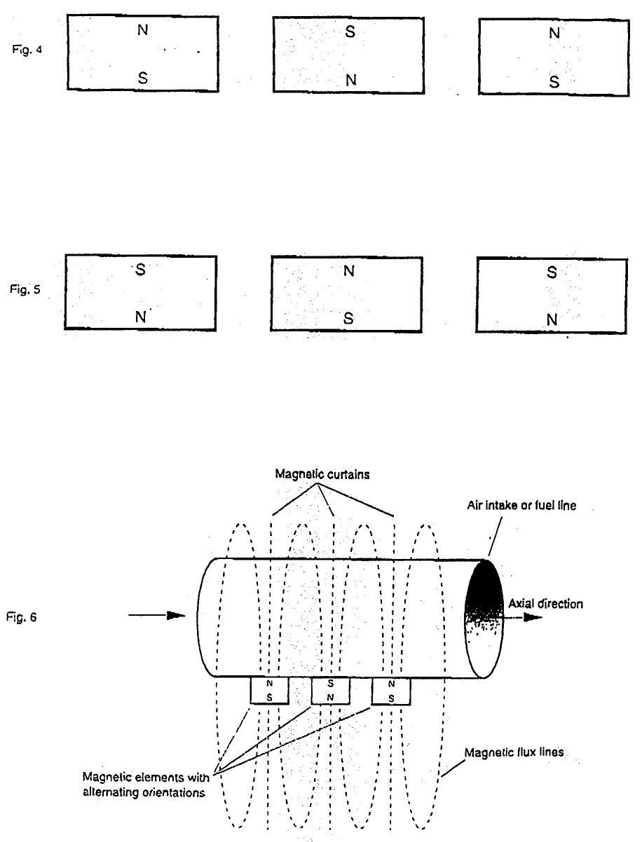

FIG. 6 shows an embodiment similar to the one shown in FIG. 2.

It is believed that the positive effect of the magnetic pre-treatment of the air and/or fuel is due to the disruption of larger clusters of oxygen and hydrocarbons. This clustering is possibly promoted by negative ions that are found in the air intake and supply lines. It is for example known that six O₂-molecules will gather in an O₁₂-structure in the presence of electrical cohesive negative ions. It is believed that this cluster formation reduces what may be called a “reaction surface area”, and by breaking up the clusters, this “reaction surface area” is increased. By letting the air or the fuel pass a magnetic field, the influence of the field on the O₂ and hydrocarbon clusters will result in a dispersion of the clusters, making the oxygen and fuel more accessible for combustion.

The inventors of the present invention have discovered that two main features govern the effect of the magnetic field. In order to achieve significant savings in fuel consumption in addition to reduced emissions, it is paramount to orient the magnetic elements with their magnetic dipoles directed mainly perpendicularly to the direction of the air or fuel flow as shown in FIGS. 1 and 2. With a such arrangement the orientation of the magnets in relation to the air intake or fuel line will be such that the strong magnetic field right in front of the pole points directly into the air intake supply and/or fuel line. In addition to this feature, at least two magnetic elements must be arranged next to each other while the orientation of the magnetic elements alternate. This arrangement has proven to not only reduce emissions significantly, but also lead to proven fuel consumption savings, unlike the arrangements according to the prior art.

Although the magnetic strength of the magnets is believed to be of some importance, their strength appears to be of far less importance than believed in some prior art publications. Increasing magnetic strength beyond a certain value that can be determined experimentally seems to produce no further improvement in fuel savings and emissions reduction. Instead, it is the mentioned arrangement of the magnets that increases the effect of the magnetic field and also results in considerable fuel savings. This important feature of the invention has apparently not been understood or mentioned in the prior art, as it is not explicitly been mentioned in any of the publications that are known to the applicant.

Experience shows that the neighbouring magnets with opposing orientations do not necessarily have to abut each other. They may abut each other, but may just as well be arranged somewhat apart. The inventors are in the process of investigating which distances between the magnets provide the optimal effect.

Similarly, although tests until now have shown that a perfectly perpendicular orientation of the magnetic dipoles seems to be optimal, it is possible that orientations other than 90°, but still close to 90°, with respect to the axial direction of the air intake or fuel line, may yield a result that is more optimal in regard to either fuel savings or reduced emissions, or both. The inventors are in the process of investigating if such tuning of the orientations of the magnets, with respect to each other and the axial direction, may provide for further advantageous effects.

In the prior art, a magnetic treatment of either the air or the fuel, or both, has been described, but their interrelatedness has not been clearly mentioned or investigated. The inventors of the present invention have found an important relationship between the magnetic treatment of air and fuel, namely that the effect of a magnetic treatment on fuel at best is minute as long as it is not accompanied with an efficacious magnetic treatment of the air. The total contribution of the magnetic treatment of air is far greater than the contribution of the magnetic treatment of fuel, but the contribution of the magnetic treatment of fuel is wholly dependent on the magnet treatment of air, but not the other way around. Why this is so, is not clear at the present time, but the inventors of the present invention are investigating possible causes at the present time, at the same time as they are trying to determine if there are other factors that may affect the interrelationship, e.g. if there is one configuration of magnets that is optimal for air and another that is optimal for fuel, if a specific orientation of magnets in relation to the magnetic treatment of air warrants a specific different orientation of magnets in relation to the magnetic treatment of fuel and/or vice versa. For the time being, the optimal and preferred configuration is as follows: Three magnets with alternating orientations (preferably S, N, S), perpendicular with respect to the axial direction of the air intake line, is combined with the use of two oppositely oriented magnets (preferably N, S), perpendicularly with respect to the axial direction of the fuel line. The three magnets in the air intake line and two magnets on the fuel line may for example be attached by means of straps if they are to be retrofitted, or they may be integrally arranged in air intake line or fuel line, respectively. This configuration provides the optimal reduction in both fuel consumption and emissions.

It appears to be a significant feature that the magnets are arranged on only one side of the air intake line and the fuel line, and not on opposite sides or in any way symmetrically around the air intake line and the fuel line. This is believed to be because a symmetric arrangement in some way contributes to distort the magnetic “curtain” and instead create magnetic “loopholes” and fails to produce a sufficiently alternating field. This appears to be the reason why the prior art arrangements have failed to prove a reduction in fuel consumption. One possible exception is if two long magnets where arranged on opposite sides of the air intake line and the fuel line. This would produce a “thick” magnetic “curtain” that may prove to be advantageous, but this arrangement fails to create an alternating perpendicular field, and this feature is, as mentioned, of great importance.

In principle, any kind of element that produces a suitable magnet field may be used according to the present invention. In the preferred embodiment of the present invention, three permanent magnets are used for the air intake, while it is found that two permanent magnets are sufficient for the fuel line. It may be feasible to use electrical magnetising means instead of permanent magnets, e.g. coils through which a current is passed, either from a battery or a power supply. An embodiment of this kind may provide for controllable magnetic fields that may prove advantageous, e.g. by linking it to an electronic fuel and air supply system or other control means in a vehicle, wherein the magnetic field produced may be shaped to meet specific demands under specific conditions. Changing conditions such as varying loads, rpms, temperatures, particle content in the incoming air, fuel quality etc. may be met by shaping optimal magnetic fields and producing optimal magnetic field strengths for the individual conditions.

Regardless of what kind of magnetic element is used, it is important that the magnetic flux lines run predominantly perpendicularly to the axial direction of the air intake or fuel line in front of the poles, and in addition forms an alternating field.

A further factor that seems to be of some importance is the kind of pole that last affects the flowing fluid in an air intake supply and fuel intake, respectively. While the exact reason for this beneficent effect is not yet known or understood, empirical studies show that it is most advantageous to have an arrangement where a south pole last affects the flowing fluid, i.e. an arrangement with the order S, N, S for the air intake and N, S for the fuel line, that is, with a south pole S arranged closest to the combustion chamber. The alternate arrangement (N, S, N or S, N) also yields significant benefits compared to having no magnetic elements, but a S, N, S and N, S arrangement is better.

Practical experience which gasoline fuelled cars with an average engine size of two litres, arranged with a device according to the present invention, has shown an average fuel reduction of 8%.

Practical experience which diesel fuelled cars with an average engine size of two litres, arranged with a device according to the present invention, has shown an average fuel reduction of 10%.

Practical experience which diesel fuelled trucks with an average engine size of eight litres, arranged with a device according to the present invention, has shown an average fuel reduction of 8%.

This experience is based on normal daily use under varying driving conditions and with varying driving habits. The reason why the gasoline fuelled cars with an average engine size of two litres do not obtain the same reduction as diesel fuelled cars with the same engine size, is that gasoline fuelled engines normally run on higher rpms than diesel fuelled engines. At higher the rpms, a larger the amount of air has to be pre-treated and the air passes the magnetic fields at a quicker rate, resulting in a shorter residence time in the magnetic field. It is possible that using larger magnets or more magnets may offset the effects of the higher flow rates and contribute to level out the differences.

1. A device for magnetic pre-treatment of air passing through an air intake supply leading to a combustion chamber said magnetic pre-treatment being carried out by means of magnetic elements arranged in connection with the air intake supply,
wherein at least two magnetic elements are arranged on one side of and adjacent to said air intake supply, said at least two magnetic elements being oriented with their dipole direction pointed mainly perpendicularly to an axial incoming direction of said air intake supply, the at least two magnetic elements further being arranged substantially next to each other with alternating pole orientations, the dipole direction of said magnetic elements being arranged in succession in the order N, S, N . . . etc. or S, N, S . . . etc.

2. A device according to claim 1,
wherein three magnetic elements are arranged in succession in the order S, N, S.

3. A device according to claim 1,
wherein at least two magnetic elements are arranged on one side of and adjacent to a fuel line, said at least two magnetic elements being oriented with their dipole direction pointed mainly perpendicularly to an axial incoming direction of said fuel line, the at least two magnetic elements further being arranged substantially next to each other with alternating pole orientations, dipole direction of said magnetic elements being arranged in succession in the order N, S, N . . . etc. or S, N, S . . . etc.

4. A device according to claim 3,
wherein two magnetic elements are arranged in succession in the order N, S.

5. A device according to claim 1,
wherein it is arranged as close as possible to the combustion chamber along said air intake supply.

6. A device according to claim 3,
wherein it is arranged as close as possible to the combustion chamber along said fuel line.

7. A device according to claim 1,
wherein said magnetic elements may comprise permanent magnets, electromagnets or any other suitable magnetic means.

8. A device according to claim 3,
wherein said magnetic elements may comprise permanent magnets, electromagnets or any other suitable magnetic means.

9. A device according to claim 7,
wherein a optimal magnetic field is individually and continuously shaped by controlling the magnetic field strength, the produced magnetic field strength being controlled by means of a fuel injection system or other controlling means that monitors one or more of the following parameters: engine load, engine rpm, fuel consumption, fuel-to-air ratio and engine emissions, engine temperature, inlet air quality and inlet fuel quality.

10. A device according to claim 7,
wherein a optimal magnetic field is individually and continuously shaped by controlling said magnets orientation, the magnets orientations being controlled by means of a fuel injection system or other controlling means that monitors one or more of the following parameters: engine load, engine rpm, fuel consumption, fuel-to-air ratio and engine emissions, engine temperature, inlet air quality and inlet fuel quality.
